(19) United States
(12) Patent Application Publication
(10) Pub. No.: US 2017/0230807 A1
(43) Pub. Date: Aug. 10, 2017

(54) METHOD FOR CONSULTING THE STATUS OF A RESOURCE OF AN ELECTRONIC DEVICE, ASSOCIATED ELECTRONIC ENTITY AND ELECTRONIC DEVICE PROVIDED WITH SUCH AN ELECTRONIC ENTITY

(71) Applicant: OBERTHUR TECHNOLOGIES, Colombes (FR)

(72) Inventors: Damien LIEUPART, Colombes (FR); Elder DOS SANTOS, Colombes (FR)

(21) Appl. No.: 15/502,014

(22) PCT Filed: Jul. 27, 2015
(86) PCT No.: PCT/FR2015/052079

§ 371 Date: Feb. 6, 2017

(30) Foreign Application Priority Data
Aug. 6, 2014 (FR) 1457647

(51) Int. Cl. H04W 4/20; H04W 4/00

(52) U.S. Cl. CPC H04W 4/20; H04W 4/008; H04W 4/003

(57) ABSTRACT

Disclosed is a method for consulting, by an electronic entity (EE), the status of a resource (S, K) of an electronic device provided with a contactless module (CLF) and the electronic entity (EE), including the following steps: transmission, by the electronic entity (EE), of a resource (S, K) status request;—reception of a piece of resource (S, K) status information in response to the request;—storing of the resource (S; K) status information (INF);—execution of at least a part of an application (APPL) by a processor of the electronic entity (EE);—calling, as a result of the execution of the application (APPL), of a programming interface (API), resulting in the reading of the piece of stored resource (S, K) status information. An associated electronic entity and electronic device provided with such an electronic entity are also proposed.

### TECHNICAL FIELD TO WHICH THE INVENTION RELATES

The present invention relates to the use of a resource of an electronic device by an electronic entity equipping this electronic device.

It more particularly relates to a method of consulting the status of a resource of an electronic device, an associated electronic entity and an electronic device equipped with such an electronic entity.

The invention particularly advantageously applies to the case where the electronic device is also equipped with a contactless module and where the electronic entity can control the contactless module and exchange data, through the contactless module, with a processor of the electronic device.

TECHNOLOGICAL BACK-GROUND

In order to be able to exchange data between an electronic device and an external device with the possibility to use certain cryptographic protocols (for example, encryption or authentication protocols), it is known to equip the electronic device with a contactless module (for example, of the NFC type) and an electronic entity, generally secure, such as a microcircuit card.

It is generally provided in this type of architecture that the electronic entity is activated and takes the control of the contactless module when a communication is established via the contactless link, for example when the electronic device is brought close to a reader.

Within the framework of its operation, the electronic entity may then try to use certain resources of the electronic device, for example the user interface. The application executed by the electronic entity may indeed want to communicate a message to the user and/or receive information from the user (such as a PIN code).

It has therefore been provided that the electronic entity can obtain information about the status of the resource it tries to use, for example, in the document “GlobalPlatform Card, Contactless Services, Card Specification v2.2-Amendment C”, version 1.1 (April 2013), by means of a programming interface called getHostDeviceUserInterfaceState.

### OBJECT OF THE INVENTION

In this context, the present invention proposes a method of consulting, by an electronic entity, the status of a resource of an electronic device equipped with a contactless module and with the electronic entity, comprising the following steps (in this order):
transmitting, by the electronic entity, a resource status request;
receiving resource status information in response to said request;
storing the resource status information;
executing a part at least of an application by a processor of the electronic entity;
invoking, due to the execution of the application, a programming interface causing the reading of said stored resource status information.

The resource status information is thus obtained (and stored) before the effective implementation of the application that uses this information. The resource status information will hence be immediately available (by reading the stored information) for the application that uses it and an exceeding of the maximum time of transaction provided for certain applications (for example in the bank field) can hence be avoided.

According to optional (and hence non-limitative) characteristics:
the resource status request is transmitted by the electronic entity to the contactless module;
the resource status request is transmitted by the contactless module to a processor of the electronic device;
the resource status information is stored into the electronic entity;
the step of transmitting the resource status request is performed as soon as a contactless session is initiated between the contactless module and an external device;
the step of transmitting the resource status request is performed as soon as said application is selected to be executed;
the resource status information is transmitted from the contactless module to the electronic entity after said application has been selected to be executed;
the resource is a user interface of the electronic device;
the electronic entity is a microcircuit card integrated to the electronic device or a secure element integrated to the electronic device.

The invention also proposes an electronic entity designed to equip an electronic device comprising a contactless module and offering a resource, the electronic entity comprising a module for transmitting a resource status request; a module for receiving resource status information in response to said request; a module for storing the resource status information; a processor designed to execute a part at least of an application; and a mechanism for invoking a programming interface designed to read said stored resource status information, the mechanism for invoking the programming interface being activated due to the execution of the application.

These modules may in practice be made by a combination of hardware elements and software elements. Hence, for each module, the electronic entity stores for example software instructions executable by the processor of the electronic entity in order to use a hardware element (for example a communication interface or a memory) and to hence implement the functionality offered by the module.

The invention further proposes an electronic device offering a resource and equipped with a contactless module and an electronic entity as mentioned hereinabove.

The optional characteristics proposed hereinabove as regards the consulting method may also apply to this electronic entity and/or to this electronic device.

### DETAILED DESCRIPTION OF AN EXEMPLARY EMBODIMENT

The following description with regard to the appended drawings, given by way of non-limitative examples, will allow a good understanding of what the invention consists in and how it may be made.

In the appended drawings:

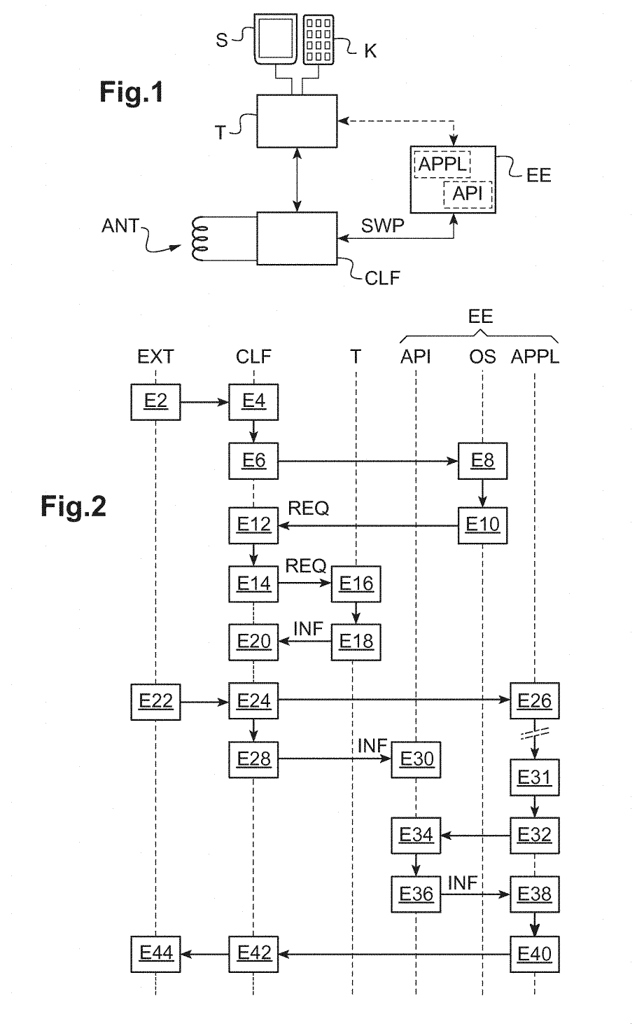

FIG. 1 shows the main elements of an electronic device used within the framework of the invention;

FIG. 2 shows, as a logical diagram, an example of method according to the invention.

FIG. 1 schematically shows the main elements of an electronic device in which the invention can be implemented.

The electronic device is herein a communication terminal, some functionalities of which (in particular functionalities of communication over a communication network) are managed by a processor T. The processor T is for example a microcontroller that comprises a microprocessor and one or several memory(ies).

Within the framework of the terminal operation, the processor T manages in particular a user interface implemented by means of a screen S and a keyboard K. As a variant, another type of user interface, for example implemented by a touch-screen, could be used.

The electronic device also comprises a contactless module CLF (sometimes called “ContactLess Front-end”), designed to establish, by means in particular of an antenna ANT, a wireless link, herein of short range, with an external device, generally equipped with a contactless module of the same type. The established wireless link allows data exchanges between the electronic device and the external device. It is for example an NFC-type link.

In order to secure these exchanges, the electronic device comprises an electronic entity EE, herein a secure electronic entity such as a microcircuit card, for example a microcircuit card integrated (typically welded) to the electronic device or eUICC for “embedded Universal Integrated Circuit Card”, or a secure element, for example a secure element integrated (typically welded) to the electronic device or eSE for “embedded Secure Element”.

The electronic entity EE also comprises a microprocessor and memories associated with this microprocessor (for example, a random-access memory and a rewritable non-volatile memory). One at least of these memories (herein the rewritable non-volatile memory) stores instructions of various computer programs (in particular, herein, an operating system OS, a programming interface API and an application APPL, or applet). The electronic entity implements methods, in particular those described hereinafter, due to the execution of these instructions by its microprocessor.

The electronic entity EE and the contactless module CLF are connected by means of a wire link, for example of the SWP (“Single Wire Protocol”) type, and can hence exchange data or commands between each other, as described hereinafter. This link is for example compliant with the standard ETSI TS 102 622 version 12.0.

The processor T of the terminal and the contactless module CLF are also connected by means of a wire link, for example of the SWP type. As an alternative, it may be a link of the UART (“Universal Asynchronous Receiver Transmitter”) type, the I2C (“Inter Integrated Circuit”) type, or the SPI (“Serial Peripherical Interface”) type.

In some configurations, the electronic entity EE and the processor T may be directly connected by a wire link (shown in dotted line in FIG. 1). This link is however not used in the example presented herein and will hence not be further described.

FIG. 2 shows an example of method implemented in particular within the electronic device according to the invention.

The method begins by step E2 at which a contactless link is established between the electronic device and an external device EXT (such as an NFC reader), for example after the bringing of the electronic device and the external device EXT close to each other (so that the antenna ANT enters a zone of action of a magnetic field produced by the external device EXT).

A message of initialization is then transmitted from the external device EXT and received by the contactless module CLF at step E4.

The contactless module CLF transmits at step E6 a message signaling the beginning a contactless session to the electronic entity EE.

This message is received at step E8 by the electronic entity EE, in which is then executed a program of management of the basic functionalities, for example an operating system OS.

The electronic entity EE may then implement various steps of initialization of its operation. In particular, the electronic entity EE transmits to the contactless module CLF (herein due to the execution of the operating system OS) a user interface status request REQ (step E10).

This user interface status request REQ is received by the contactless module CLF at step E12 and forwarded by the contactless module CLF to the processor T at step E14.

The processor T receives the user interface status request at step E16, determines the status of the user interface (for example by consulting a dedicated register stored within the processor T that manages, as already mentioned, the user interface) and sends at step E18 information INF indicative of this status to the contactless module CLF.

As an alternative, the contactless module CLF could receive this information INF on a periodical basis.

It is to be noticed that information about various parts of the user interface may hence be sent, for example information relative to the potential availability of the screen S and information relative to the potential availability of the keyboard K. Typically, each information indicates if the concerned part of the user interface is available or not.

The contactless module CLF hence receives at least one user interface status information item INF at step E20 and, in the embodiment described herein, stores this status information INF in a dedicated memory area of the contactless module CLF. As a variant, the user interface status information INF could be (immediately) transmitted to the electronic entity EE to be stored in a memory of the electronic entity EE.

During step E22, the external device EXT transmits a command (for example, of the APDU “Application Protocol Data Unit” type) aiming to launch the execution of the application (or applet) APPL within the electronic entity EE.

This command is received at step E24 by the contactless module CLF, that transmits it to the electronic entity EE, which causes the selection and the launching of the application APPL by the electronic entity EE at step E26.

The contactless module CLF then further transmits (step E28) the user interface status information INF to the programming interface API that, as already indicated, is located on the electronic entity. For that purpose, the user interface status information INF is transmitted by the contactless module CLF to the electronic entity EE and stored in memory of the electronic entity EE (step E30), being accessible by invoking the programming interface API as described hereinafter (without prompting the programming interface API at that time).

According to a conceivable variant, it may be provided that steps E14 to E20 of requesting REQ the user interface status and of receiving user interface status information INF are not performed during the initialization of the wireless exchange session as proposed hereinabove, but during the selection of the application APPL, i.e. between steps E24 and E28 that have just been described.

In any case, the execution of the application APPL by the microprocessor of the electronic entity EE is continued, after the launching thereof at step E26, with steps E31 peculiar to this application, not described herein, up to step E32, at which the application APPL consults the status of the user interface (typically before asking to use the latter).

For that purpose, the application APPL executed by the microprocessor of the electronic entity EE invokes the programming interface API (for example, an interface of the getHostDeviceUserInterfaceState type).

The programming interface API is hence then executed by the microprocessor of the electronic entity (step E34), reads in memory the user interface status information INF (received and stored at step E30) and may hence send (almost immediately) this user interface status information INF back to the application APPL (step E36).

The application APPL receives at step E38 the user interface status information INF and may hence use this information INF in the subsequent steps of its operation. The fact that this status information INF has been determined beforehand (at step E16 in the example described herein, or just after the selection of the application according to the already mentioned variant) is not problematic, taking into account the brevity of the contactless sessions (less than 200 ms).

For example, if the status information INF indicates that the user interface is not available for inputting a PIN (“Personal Identification Number”) code, the application may send back an error message to the external device EXT via the contactless module (wherein step E42 can then consist in sending this error message).

If, on the other hand, the status information INF indicates that the user interface is available, the application APPL controls for example the display on the screen S of a message asking the user to input its PIN code and waits in return for the input of the PIN code on the keyboard K. It may then be provided, if the identification of the user is correct (i.e. if the input PIN code corresponds to a PIN code stored in the electronic entity EE), that step E40 consists in controlling the sending by the contactless module CLF (step E42) of user authentication information.

The external device EXT receives in this case the expected information (herein authentication information) at step E44.

In the example that has just been presented, the selection of the application (steps E22 to E26) is made after the module CLF has received the resource status information INF (herein, the user interface) from the processor T (step E20). It is however conceivable that the selection of the application is made before the resource status information INF is delivered by the processor T of the electronic device, these two processes being implemented in parallel.

Be that as it may, the resource status request REQ being transmitted early enough (from the initiation of the contactless link or, as a variant, from the selection of the application APPL), the resource status information INF will be available (because it is stored and can hence be consulted by the electronic entity EE) when the application APPL will try to consult it.

1. A method of consulting, by an electronic entity, the status of a resource of an electronic device equipped with a contactless module and the electronic entity, comprising the following steps:
transmitting, by the electronic entity, a resource status request;
receiving resource status information in response to said request;
storing the resource status information;
executing a part at least of an application by a processor of the electronic entity;
invoking, due to the execution of the application, a programming interface causing the reading of said stored resource status information.

2. The consulting method according to claim 1, wherein the resource status request is transmitted by the electronic entity to the contactless module.

3. The consulting method according to claim 2, wherein the resource status request is transmitted by the contactless module to a processor of the electronic device.

4. The consulting method according to claim 1, wherein the resource status information is stored into the electronic device.

5. The consulting method according to claim 1, wherein the step of transmitting the resource status request is performed as soon as a contactless session is initiated between the contactless module and an external device.

6. The consulting method according to claim 1, wherein the step of transmitting the resource status request is performed as soon as said application is selected to be executed.

7. The consulting method according to claim 1, wherein the resource status information is transmitted from the contactless module to the electronic entity after said application has been selected to be executed.

8. The consulting method according to claim 1, wherein the resource is a user interface of the electronic device.

9. The consulting method according to claim 1, wherein the electronic entity is a microcircuit card integrated to the electronic device.

10. The consulting method according to claim 1, wherein the electronic entity is a secure element integrated to the electronic device.

11. An electronic entity designed to equip an electronic device comprising a contactless module and offering a resource, the electronic entity comprising:
a module for transmitting a resource status request;
a module for receiving a resource status information in response to said request;
module for storing the resource status information;
a processor designed to execute a part at least of an application; and
a mechanism for invoking a programming interface designed to read said stored resource status information, the mechanism for invoking the programming interface being activated due to the execution of the application.

12. An electronic device offering a resource and equipped with a contactless module and an electronic entity according to claim 11.

13. The consulting method according to claim 2, wherein the resource status information is stored into the electronic device.

14. The consulting method according to claim 3, wherein the resource status information is stored into the electronic device

15. The consulting method according to claim 2, wherein the step of transmitting the resource status request is performed as soon as a contactless session is initiated between the contactless module and an external device.

16. The consulting method according to claim 3, wherein the step of transmitting the resource status request is performed as soon as a contactless session is initiated between the contactless module and an external device

17. The consulting method according to claim 4, wherein the step of transmitting the resource status request is performed as soon as a contactless session is initiated between the contactless module and an external device

18. The consulting method according to claim 2, wherein the step of transmitting the resource status request is performed as soon as said application is selected to be executed.

19. The consulting method according to claim 3, wherein the step of transmitting the resource status request is performed as soon as said application is selected to be executed.

20. The consulting method according to claim 4, wherein the step of transmitting the resource status request is performed as soon as said application is selected to be executed.
